(19) United States
(12) Patent Application Publication
(10) Pub. No.: US 2025/0291212 A1
(43) Pub. Date: Sep. 18, 2025

(54) OPTICAL DEVICE, RECEPTION APPARATUS, TRANSCEIVER APPARATUS, COMMUNICATION SYSTEM, TERMINAL APPARATUS, AND OPTICAL SYSTEM

(71) Applicant: TDK Corporation, Tokyo (JP)

(72) Inventors: Tetsuya SHIBATA, Tokyo (JP); Tomohito Mizuno, Tokyo (JP); Hideaki Fukuzawa, Tokyo (JP)

(73) Assignee: TDK Corporation, Tokyo (JP)

(21) Appl. No.: 19/081,579

(22) Filed: Mar. 17, 2025

(30) Foreign Application Priority Data
Mar. 18, 2024 (JP) 2024-042016

(51) Int. Cl. G02F 1/095

(52) U.S. Cl. CPC G02F 1/095; G02F 2201/34

(57) ABSTRACT

According to the present invention, an optical device includes a waveguide, a magnetic element, a first reflector, and a second reflector. The waveguide includes a core in which light propagates and a cladding covering the core. The first reflector is located forward in a traveling direction of the light propagating inside the core. The second reflector is located at a position at which the light reflected by the first reflector is radiated and the magnetic element is irradiated with the light. The magnetic element includes a first ferromagnetic layer, a second ferromagnetic layer, and a spacer layer located between the first and second ferromagnetic layers. The magnetic element is irradiated with light from a lateral side or from above.

### BACKGROUND OF THE INVENTION

### Field of the Invention

The present invention relates to an optical device, a reception apparatus, a transceiver apparatus, a communication system, a terminal apparatus, and an optical system.

Priority is claimed on Japanese Patent Application No. 2024-042016, filed Mar. 18, 2024, the content of which is incorporated herein by reference.

### Description of Related Art

Photoelectric conversion elements are used in various applications.

For example, Patent Document 1 discloses a reception apparatus that receives an optical signal using a photodiode. The photodiode is, for example, a pn junction diode or the like in which a semiconductor pn junction is used and converts light into an electrical signal.

For example, Patent Document 2 discloses a new optical device in which a magnetic element is used. In the magnetic element, when light is radiated, a magnetic state changes and a resistance value changes.

### PATENT DOCUMENTS

[Patent Document 1] Japanese Unexamined Patent Application, First Publication No. 2001-292107
[Patent Document 2] Japanese Unexamined Patent Application, First Publication No. 2022-155468

### SUMMARY OF THE INVENTION

Patent Document 2 discloses that light is radiated from the lower side of the magnetic element using a reflector. In this case, however, sufficient intensity of an optical device cannot be obtained in some cases.

The present invention has been devised in view of such circumstances and an object of the present invention is to provide an optical device, a reception apparatus, a transceiver apparatus, a communication system, a terminal apparatus, and an optical system that are highly sensitive.

To solve the above problem, the following mechanisms are provided.

According to an embodiment of the present invention, an optical device includes a waveguide, a magnetic element, a first reflector, and a second reflector. The waveguide includes a core in which light propagates and a cladding covering the core. The first reflector is located forward in a traveling direction of the light propagating inside the core. The second reflector is located at a position at which the light reflected by the first reflector is radiated and the magnetic element is irradiated with the light. The magnetic element includes a first ferromagnetic layer, a second ferromagnetic layer, and a spacer layer located between the first ferromagnetic layer and the second ferromagnetic layer. The magnetic element is irradiated with light from a lateral side or from above.

The optical device, the reception apparatus, the transceiver apparatus, the communication system, the terminal apparatus, and the optical system according to the aspect of the present invention are highly sensitive.

### BRIEF DESCRIPTION OF THE DRAWINGS

FIG. 1 illustrates a perspective view of an optical device according to a first embodiment.

FIG. 2 illustrates a sectional view of the optical device according to the first embodiment.

FIG. 3 illustrates a plan view of the optical device according to the first embodiment.

FIG. 4 illustrates a sectional view of the vicinity of a magnetic element of the optical device according to the first embodiment.

FIG. 5 illustrates a diagram of an operation example of the magnetic element according to the first embodiment.

FIG. 6 illustrates a diagram of an operation example of the magnetic element according to the first embodiment.

FIG. 7 illustrates a sectional view of an optical device according to a first modification.

FIG. 8 illustrates a sectional view of an optical device according to a second modification.

FIG. 9 illustrates a sectional view of a first example of a connection state of magnetic elements in an optical device according to a third modification.

FIG. 10 illustrates a sectional view of a second example of a connection state of magnetic elements in an optical device according to a third modification.

FIG. 11 illustrates a schematic view of an optical element according to a first application.

FIG. 12 illustrates a conceptual diagram of an optical system in which the optical element according to the first application is used.

FIG. 13 illustrates a schematic view of a transceiver apparatus according to a second application.

FIG. 14 illustrates a conceptual diagram of an example of a communication system.

FIG. 15 is a conceptual diagram of another example of the communication system.

### DETAILED DESCRIPTION OF THE INVENTION

Hereinafter, embodiments will be described in detail appropriately with reference to the drawings. In the drawings used for description, characteristic portions may be enlarged to facilitate understanding of features, and dimensional ratios of constituent elements may differ from actual dimensional ratios. Materials, dimensions, and the like exemplified in the following description are exemplary and the present invention is not limited thereto. Modifications can be appropriately made within the scope in which the advantages of the present invention are achieved.

Directions are defined as follows. One direction in a plane on which a substrate extends is defined as the X direction and a direction perpendicular to the X direction in the plane is defined as the Y direction. For example, a direction in which a core 11 extends near an output end of the core 11 is defined as the X direction. A direction perpendicular to the substrate is defined as the Z direction. The Z direction is an example of a stacking direction of a magnetic element 20. Hereinafter, the +Z direction is expressed as “Up” and the −Z direction is expressed as “Down” in some cases. The +Z direction is a direction oriented from the core to the magnetic element. Up and Down do not necessarily match a direction of a gravitational force.

### First Embodiment

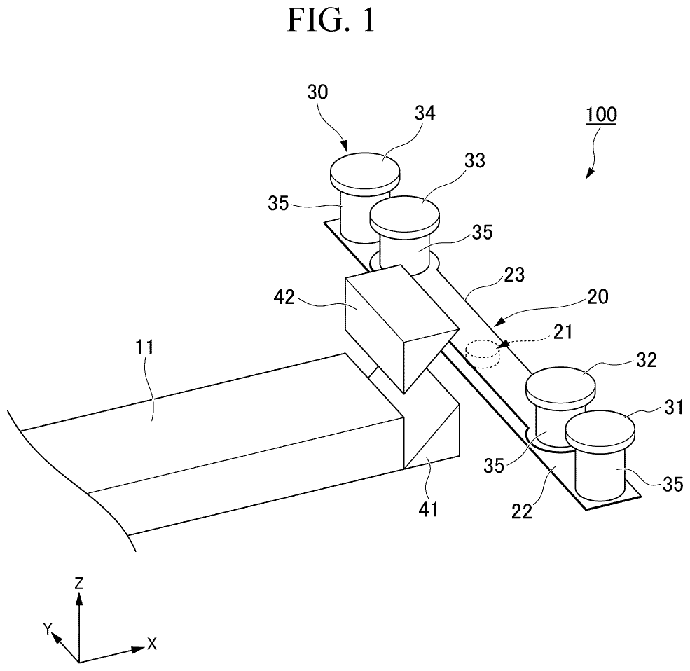

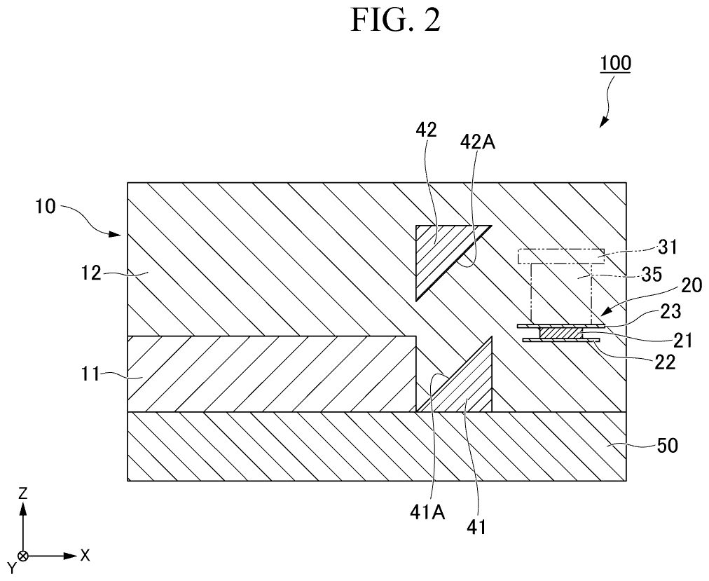

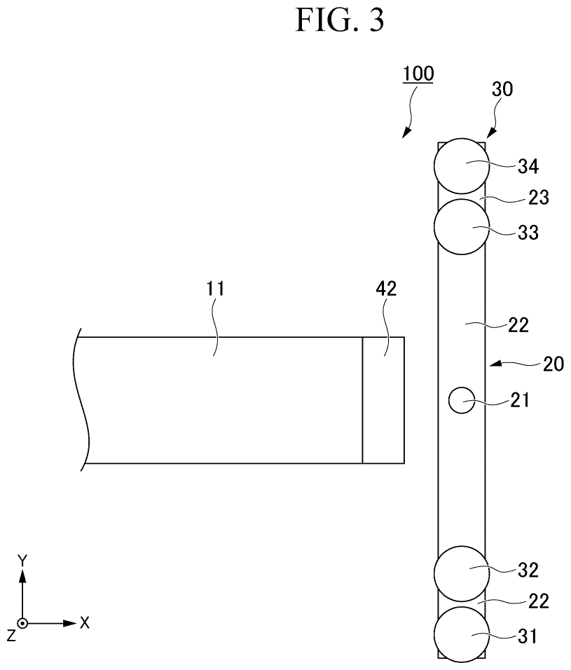

FIG. 1 illustrates a perspective view of an optical device 100 according to a first embodiment. FIG. 2 illustrates a sectional view of the optical device 100 according to the first embodiment. FIG. 2 illustrates an XZ cross-section passing through a center of the core 11 in the Y direction. FIG. 3 illustrates a plan view of the optical device 100 according to the first embodiment. In FIGS. 1 and 3, a cladding 12 and a substrate 50 are omitted.

The optical device 100 includes, for example, a waveguide 10, a magnetic element 20, a terminal unit 30, a first reflector 41, a second reflector 42, and the substrate 50.

The waveguide 10, the magnetic element 20, the terminal unit 30, the first reflector 41, and the second reflector 42 are formed on the substrate 50. The substrate 50 is, for example, a semiconductor substrate, an aluminum oxide substrate, or a sapphire substrate.

The waveguide 10 is a structure that forms a path along which light propagates. Light in the present specification is not limited to visible light and includes infrared light with longer wavelengths than the visible light and ultraviolet light with shorter wavelengths than the visible light. The wavelength of the visible light is, for example, 380 nm or more and less than 800 nm. The wavelength of the infrared light is, for example, 800 nm or more and 1 mm or less. The wavelength of the ultraviolet light is, for example, 200 nm or more and less than 380 nm. The light propagating along the waveguide 10 is, for example, laser light.

The waveguide 10 includes, for example, the core 11 and the cladding 12. The waveguide 10 executes total reflection of light by a refractive index difference between the core 11 and the cladding 12. Light propagates within the core 11. A first end of the core 11 is irradiated with light from, for example, a laser diode. A second end of the core 11 faces the first reflector 41. The cladding 12 covers the surroundings of the core 11.

The core 11 contains, for example, lithium niobate as a main component. Some elements of the lithium niobate may be substituted with other elements. The cladding 12 is formed of, for example, SiO₂, Al₂O₃, MgF₂, La₂O₃, ZnO, HfO₂, MgO, Y₂O₃, CaF₂, In₂O₃, or a mixture thereof. The materials of the core 11 and the cladding 12 are not limited to the examples. For instance, the core 11 may be formed of silicon or a silicon oxide to which a germanium oxide is added, while the cladding 12 may be formed of a silicon oxide. For example, the core 11 may also be formed of a tantalum oxide (Ta₂O₅) and the cladding 12 may also be formed of a silicon oxide or an aluminum oxide.

The magnetic element 20 is located inside the cladding 12. The magnetic element 20 may be in the same layer as or a different layer from the core 11 in the Z direction. The magnetic element 20 is located at a position at which the magnetic element 20 is irradiated from the lateral side or from above with light propagating in the core 11 and reflected by the second reflector 42. The magnetic element 20 is, for example, located in front of the first reflector 41 and the second reflector 42 in the traveling direction of light L propagation through the core 11 (for example, in the X direction).

The magnetic element 20 substitutes a state of the radiated light or a change in the state with an electrical signal. The magnetic element 20 is irradiated with light with a wavelength of, for example, 400 nm or more and 1500 nm or less.

The magnetic element 20 generates a voltage when light is radiated. When a state of the radiated light is changed, a resistance value of the magnetic element 20 in the z direction changes according to the change in the state of the light. When the state of the light radiated to the magnetic element 20 changes, an output voltage from the magnetic element 20 changes according to the change in the state of the light.

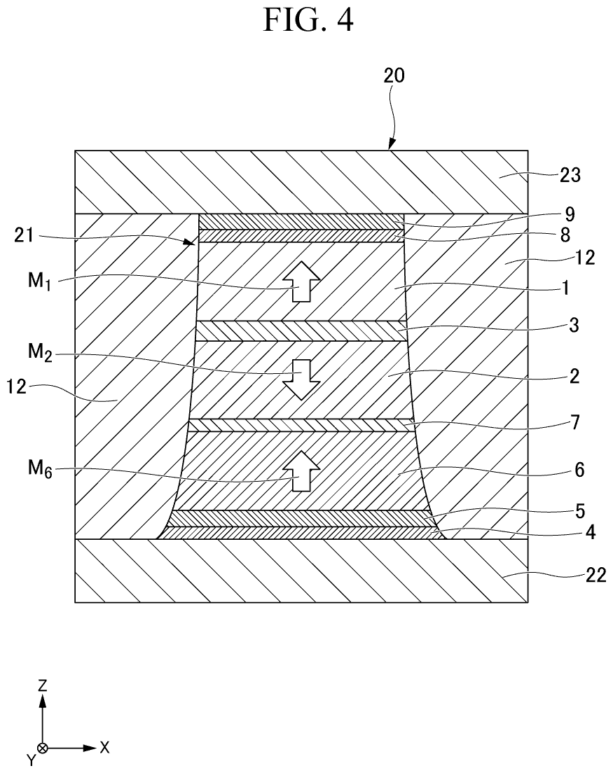

FIG. 4 illustrates a sectional view of the vicinity of the magnetic element 20 of the optical device 100 according to the first embodiment. The magnetic element 20 includes a stacked body 21, a first electrode 22, and a second electrode 23.

The first electrode 22 is located in the stacked body 21 on the substrate 50 side. The first electrode 22 is conductive. The first electrode 22 is formed of, for example, a metal such as Cu, Al, Au, Ta, or Ti. Ta or Ti may be stacked above and below the metal. In the first electrode 22, a stacked film of Cu and Ta, a stacked film of Ta, Cu, and Ti, or a stacked film of Ta, Cu, and TaN may be used. The first electrode 22 may be formed of TiN or TaN. When the first electrode 22 contains such a material, crystallinity of the stacked body 21 increases. Since the crystallinity of the stacked body 21 contributes to a resistance change range in the Z direction of the stacked body 21, the sensitivity of the optical device 100 is thus affected.

The first electrode 22 is preferably formed of, for example, a metal including at least one element selected from a group consisting of ruthenium, molybdenum, and tungsten. The first electrode 22 may be a single-layer film of either ruthenium, molybdenum, or tungsten or may be a multilayer film that has at least one layer of either ruthenium, molybdenum, or tungsten. Ruthenium, molybdenum, and tungsten have high melting points (2000° C. or higher) and excellent heat resistance. The first electrode 22 containing these elements rarely deteriorates during heat treatment during crystallization of the stacked body 21 or heat treatment during semiconductor processing.

The second electrode 23 faces the first electrode 22. The first electrode 22 and the second electrode 23 sandwich the stacked body 21 in the Z direction. The second electrode 23 is formed of a conductive material. The second electrode 23 is formed of, for example, a metal such as Cu, Al, or Au. The second electrode 23 may have Ta or Ti stacked above and below the metal. As the second electrode 23, a stacked film of Cu and Ta, a stacked film of Ta, Cu, and Ti, or a stacked film of Ta, Cu, and TaN may be used. TiN or TaN may be used as the second electrode 23. When both the first electrode 22 and the second electrode 23 are not transparent to light in the wavelength band for use, light is radiated from the lateral side of the magnetic element 20.

The second electrode 23 is preferably a transparent electrode that is transparent to light in a wavelength band for use. For example, the second electrode 23 preferably transmits 80% or more of the light in the wavelength band for use. The second electrode 23 is, for example, an oxide such as an indium tin oxide (ITO), an indium zinc oxide (IZO), a zinc oxide (ZnO), or an indium gallium zinc oxide (IGZO). The second electrode 23 may also be a metal film with a thickness of about 3 nm to 10 nm. When the second electrode 23 is a transparent electrode, light can be radiated to the stacked body 21 from above, which can achieve efficient irradiation of the stacked body 21 with light.

The stacked body 21 is sandwiched between the first electrode 22 and the second electrode 23. The stacked body 21 includes, for example, a first ferromagnetic layer 1, a second ferromagnetic layer 2, and a spacer layer 3. The spacer layer 3 is located between the first ferromagnetic layer 1 and the second ferromagnetic layer 2. The stacked body 21 may include other layers. The stacked by 21 may include, for example, a buffer layer 4, a seed layer 5, a third ferromagnetic layer 6, a magnetic coupling layer 7, a perpendicular magnetization induction layer 8, and a cap layer 9.

The magnetic element 20 is a magnetic element including a ferromagnetic body. For example, when the spacer layer 3 is formed on an insulator, the magnetic element 20 includes a magnetic tunnel junction (MTJ) formed by the first ferromagnetic layer 1, the spacer layer 3, and the second ferromagnetic layer 2. Such an element is referred to as an MTJ element. In this case, the magnetic element 20 can exhibit a tunnel magnetoresistance (TMR) effect. When the spacer layer 3 is formed of metal, the magnetic element 20 can exhibit a giant magnetoresistance (GMR) effect. Such an element is called a GMR element. The magnetic element 20 may have different names such as MTJ element or GMR element depending on a material of the spacer layer 3, but it is also collectively called a magnetoresistive effect element. In the magnetic element 20, a resistance value in the z direction (a resistance value when a current flows in the z direction) changes according to a relative change between a magnetization state of the first ferromagnetic layer 1 and a magnetization state of the second ferromagnetic layer 2.

The first ferromagnetic layer 1 is a light detection layer of which a magnetization state changes when light is radiated from the outside. The first ferromagnetic layer 1 is also referred to as a magnetization free layer. The magnetization free layer is a layer that includes a magnetic body of which a magnetization state changes when predetermined energy from the outside is applied. The predetermined energy from the outside is, for example, light radiated from the outside, a current flowing in the z direction of the magnetic element 20, or an external magnetic field. The magnetization of the first ferromagnetic layer 1 changes a state according to an intensity of the light radiated to on the first ferromagnetic layer 1 (light radiated to the magnetic element 20).

The first ferromagnetic layer 1 contains ferromagnetic material. The first ferromagnetic layer 1 contains at least one magnetic element such as Co, Fe, or Ni. The first ferromagnetic layer 1 may also contain an element such as B, Mg, Hf, or Gd along with the above-described magnetic element. The first ferromagnetic layer 1 may be, for example, an alloy of both magnetic and non-magnetic elements. The first ferromagnetic layer 1 may include a plurality of layers. The first ferromagnetic layer 1 is, for example, a CoFeB alloy, a stacked body in which a CoFeB alloy layer is sandwiched between Fe layers, or a stacked body in which a CoFeB alloy layer is sandwiched between CoFe layers. In general, “ferromagnetic” includes “ferrimagnetic”. The first ferromagnetic layer 1 may exhibit ferrimagnetism. On the other hand, the first ferromagnetic layer 1 may exhibit ferromagnetism that is not ferrimagnetic. For example, the CoFeB alloy exhibits ferromagnetism that is not ferrimagnetic.

The first ferromagnetic layer 1 may be either an in-plane magnetization film that has an easy axis of magnetization in an in-plane direction (any direction in the xy plane), or a perpendicular magnetization film that has an easy axis of magnetization in a direction perpendicular to a film plane (z direction).

The thickness of the first ferromagnetic layer 1 is, for example, 1 nm or more and 5 nm or less. For example, the thickness of the first ferromagnetic layer 1 is preferably 1 nm or more and 2 nm or less. When the first ferromagnetic layer 1 is a perpendicular magnetization film and the thickness of the first ferromagnetic layer 1 is thin, a perpendicular magnetic anisotropy effect from the layers above and below the first ferromagnetic layer 1 is enhanced, which increases the perpendicular magnetic anisotropy of the first ferromagnetic layer 1. That is, when the perpendicular magnetic anisotropy of the first ferromagnetic layer 1 is high, a force for returning magnetization M₁ in the z direction becomes stronger. Conversely, when the thickness of the first ferromagnetic layer 1 is thick, the perpendicular magnetic anisotropy effect from the layers above and below the first ferromagnetic layer 1 becomes relatively weaker, which reduces the perpendicular magnetic anisotropy of the first ferromagnetic layer 1.

As the thickness of the first ferromagnetic layer 1 decreases, the volume of the ferromagnetic body becomes smaller. As the thickness of the first ferromagnetic layer 1 increases, the volume of a ferromagnetic body becomes larger. A reactivity of the magnetization of the first ferromagnetic layer 1 during application of energy from the outside is inversely proportional to a product (KuV) of magnetic anisotropy (Ku) and the volume (V) of the first ferromagnetic layer 1. That is, as the product of the magnetic anisotropy and volume of the first ferromagnetic layer 1 decreases, the reactivity to light increases. From this viewpoint, to enhance a response to light, it is preferable to reduce the volume of the first ferromagnetic layer 1 after the magnetic anisotropy of the first ferromagnetic layer 1 is appropriately designed.

When the thickness of the first ferromagnetic layer 1 is greater than 2 nm, an insertion layer formed of, for example, Mo or W may be provided within the first ferromagnetic layer 1. That is, a stacked body in which a ferromagnetic layer, an insertion layer, and a ferromagnetic layer are stacked in order in the z direction may serve as the first ferromagnetic layer 1. The perpendicular magnetic anisotropy of the entire first ferromagnetic layer 1 is enhanced by the interfacial magnetic anisotropy at the interface between the insertion layer and the ferromagnetic layer. The thickness of the insertion layer is, for example, 0.1 nm to 1.0 nm.

The second ferromagnetic layer 2 is a magnetization fixing layer. The magnetization fixing layer is a layer formed of a magnetic material of which a state of magnetization M₂ is less likely to change than that of the magnetization free layer when predetermined energy from the outside is applied. For example, the magnetization fixing layer is less likely to have a direction of the magnetization changed than the magnetization free layer when the predetermined energy from the outside is applied. For example, the magnetization fixing layer is less likely to have a magnitude of the magnetization changed than the magnetization free layer when the predetermined energy from the outside is applied. The coercivity of the second ferromagnetic layer 2 is, for example, greater than that of the first ferromagnetic layer 1. The second ferromagnetic layer 2 has, for example, an easy axis of magnetization in the same direction as the first ferromagnetic layer 1. The second ferromagnetic layer 2 may be an in-plane magnetization film or a perpendicular magnetization film.

The material of the second ferromagnetic layer 2 is, for example, similar to those of the first ferromagnetic layer 1. For example, the second ferromagnetic layer 2 may also be a multilayer film in which Co with a thickness of 0.4 nm to 1.0 nm and Pt with a thickness of 0.4 nm to 1.0 nm are alternately stacked several times. For example, the second ferromagnetic layer 2 may also be a stacked body in which Co with a thickness of 0.4 nm to 1.0 nm, Mo with a thickness of 0.1 nm to 0.5 nm, a CoFeB alloy with a thickness of 0.3 nm to 1.0 nm, and Fe with a thickness of 0.3 nm to 1.0 nm are stacked in order.

The magnetization M₂ of the second ferromagnetic layer 2 may, for example, be magnetically coupled with M₆ of the third ferromagnetic layer 6 with the magnetic coupling layer 7 therebetween. In this case, the combination of the second ferromagnetic layer 2, the magnetic coupling layer 7, and the third ferromagnetic layer 6 may also be referred to as the magnetization fixing layer. Details of the magnetic coupling layer 7 and the third ferromagnetic layer 6 will be described below.

FIG. 4 illustrates a bottom-pin structure in which the second ferromagnetic layer 2 that is a magnetization fixing layer is closer to the substrate 50 than the first ferromagnetic layer 1. However, a top-pin structure in which the second ferromagnetic layer 2 that is a magnetization fixing layer is farther from the substrate 50 than the first ferromagnetic layer 1 may be used.

The spacer layer 3 is a layer disposed between the first ferromagnetic layer 1 and the second ferromagnetic layer 2. The spacer layer 3 includes a layer formed of a conductor, an insulator, or semiconductor, or a layer including conductive points formed of a conductor within an insulator. The spacer layer 3 is, for example, a non-magnetic layer. The thickness of the spacer layer 3 can be adjusted in an orientation direction of the magnetization of the first ferromagnetic layer 1 and the second ferromagnetic layer 2 in an initial state which will be described below.

When the spacer layer 3 is formed of an insulating material, a material containing an aluminum oxide, a magnesium oxide, a titanium oxide, or a silicon oxide can be used as a material of the spacer layer 3. The insulating material may also contain an element such as Al, B, Si, or Mg, or a magnetic element such as Co, Fe, or Ni. A high magnetoresistance change ratio can be obtained by adjusting the thickness of the spacer layer 3 so that a high TMR effect between the first ferromagnetic layer 1 and the second ferromagnetic layer 2 is achieved. To efficiently utilize the TMR effect, the thickness of the spacer layer 3 may be set to be in a range of about 0.5 to 5.0 nm, or preferably about 1.0 to 2.5 nm.

When the spacer layer 3 is formed of a non-magnetic conductive material, a conductive material such as Cu, Ag, Au, or Ru can be used. To efficiently utilize the GMR effect, the thickness of the spacer layer 3 may be set to be in a range of about 0.5 to 5.0 nm, or preferably about 2.0 to 3.0 nm.

When the spacer layer 3 is formed of a non-magnetic semiconductor material, a material such as a zinc oxide, an indium oxide, a tin oxide, a germanium oxide, a gallium oxide, or ITO can be used. In this case, the thickness of the spacer layer 3 may be set to be in a range of about 1.0 to 4.0 nm.

When a layer including conductive points formed by a conductor in a non-magnetic insulator as the spacer layer 3 is applied, a structure including conductive points formed of a non-magnetic conductor such as Cu, Au, or Al in a non-magnetic insulator formed of an aluminum oxide or a magnesium oxide may be used. The conductor may also be formed of a magnetic element such as Co, Fe, or Ni. In this case, the thickness of the spacer layer 3 may be set to be in a range of about 1.0 to 2.5 nm. The conductive point is, for example, a columnar body with a diameter of 1 nm to 5 nm when viewed from a direction perpendicular to a film surface.

The third ferromagnetic layer 6 magnetically couples with, for example, the second ferromagnetic layer 2. The magnetic coupling is, for example, an antiferromagnetic coupling, which arises due to RKKY interaction. A material of the third ferromagnetic layer 6 is, for example, similar to that of the first ferromagnetic layer 1.

The magnetic coupling layer 7 is located between the second ferromagnetic layer 2 and the third ferromagnetic layer 6. The magnetic coupling layer 7 is formed of, for example, Ru, Ir, or the like.

The buffer layer 4 is a layer that mitigates lattice mismatch between different crystals. The buffer layer 4 is formed of, for example, a metal containing at least one element selected from a group consisting of Ta, Ti, Zr, and Cr, or a nitride containing at least one element selected from a group consisting of Ta, Ti, Zr, and Cu. More specifically, the buffer layer 4 is, for example, Ta (simple substance), a NiCr alloy, TaN (tantalum nitride), or CuN (copper nitride). The thickness of the buffer layer 4 is set to be in a range of, for example, 1 nm or more and 5 nm or less. The buffer layer 4 is, for example, amorphous. The buffer layer 4 is, for example, located between the seed layer 5 and the second electrode 23, and is in contact with the second electrode 23. The buffer layer 4 curbs an influence of a crystal structure of the second electrode 23 on a crystal structure of the magnetic element 20.

The seed layer 5 enhances crystallinity of the layers stacked on the seed layer 5. The seed layer 5 is, for example, located between the buffer layer 4 and the third ferromagnetic layer 6 and on the buffer layer 4. The seed layer 5 is formed of, for example, Pt, Ru, Zr, or NiFeCr. The thickness of the seed layer 5 is set to be, for example, 1 nm or more and 5 nm or less.

The cap layer 9 is located between the first ferromagnetic layer 1 and the first electrode 22. The cap layer 9 may include a perpendicular magnetization induction layer 8 that is stacked on and comes into contact with the first ferromagnetic layer 1. The cap layer 9 prevents damage to the lower layers during processing and enhances crystallinity of the lower layers during annealing.

The perpendicular magnetization induction layer 8 induces perpendicular magnetic anisotropy of the first ferromagnetic layer 1. The perpendicular magnetization induction layer 8 is formed of, for example, a magnesium oxide, W, Ta, Mo, or the like. When the perpendicular magnetization induction layer 8 is a magnesium oxide, the magnesium oxide is preferably oxygen-deficient to increase conductivity. The thickness of the perpendicular magnetization induction layer 8 is set to be, for example, 0.5 nm or more and 5.0 nm or less.

The terminal unit 30 includes, for example, a first terminal 31, a second terminal 32, a third terminal 33, a fourth terminal 34, and a plurality of via wirings 35. The first terminal 31, the second terminal 32, the third terminal 33, and the fourth terminal 34 are exposed on the cladding 12. The first terminal 31 and the fourth terminal 34 are each electrically connected to the first electrode 22 via the via wirings 35. The second terminal 32 and the third terminal 33 are each electrically connected to the second electrode 23 via the via wirings 35. A current or a voltage is input to the first terminal 31, and the second terminal 32 is connected to a reference potential. A signal is output from the third terminal 33, and the fourth terminal 34 is connected to the reference potential. The first terminal 31, the second terminal 32, the third terminal 33, the fourth terminal 34, and the plurality of via wirings 35 contain conductive materials.

The first reflector 41 and the second reflector 42 reflect light output from the core 11. The first reflector 41 and the second reflector 42 are, for example, mirrors. The first reflector 41 and the second reflector 42 are, for example, within the cladding 12.

The light output from the core 11 is reflected in the order of the first reflector 41 and the second reflector 42, and then radiated to the magnetic element 20. The light is preferably radiated to an upper surface of the magnetic element 20 in a direction inclined at 45° or more with respect to the upper surface of the magnetic element 20. That is, an angle at which the light is inclined to the magnetic element 20 is preferably in a direction inclined at 45° or more with respect to the XY plane. When the second electrode 23 is a transparent electrode, radiation efficiency of the light to the stacked body 21 is enhanced by satisfying the above condition.

The first reflector 41 is located forward in the traveling direction (for example, the X direction) of the light propagating in the core 11. The height position of the first reflector 41 in the Z direction is the same as or higher than the height position of the core 11. When viewed in the X direction, a part of a reflection surface of the first reflector 41 is at a position overlapping the core 11. The height position of the magnetic element 20 and the first reflector 41 in the Z direction may be the same, or the magnetic element 20 may be higher.

A reflection surface 41A of the first reflector 41 is located opposite to an output end of the light in the core 11. The reflection surface 41A is inclined in the +X direction with respect to a YZ plane. The light output from the core 11 is reflected by the reflection surface 41A of the first reflector 41 and is bent in the Z direction. The light reflected by the first reflector 41 may have have a component in the Z direction and is not limited to traveling in the Z direction.

The second reflector 42 is located at a position at which the light can be reflected by the first reflector 41 and the light reflected by the second reflector 42 is radiated to the magnetic element 20. When viewed in the Z direction, the second reflector 42 may be located at a position overlapping the first reflector 41 or may be located at a position in the +X direction from the first reflector 41. The height position of the second reflector 42 in the Z direction is, for example, above the magnetic element 20.

The reflection surface 42A of the second reflector 42 is inclined with respect to the YZ plane. FIG. 2 illustrates an example where the reflection surface 42A is inclined in the +X direction with respect to the YZ plane, but the reflection surface 42A may be inclined in the −X direction with respect to a YZ plane depending on a position of the magnetic element 20. In this case, the magnetic element 20 is disposed on the core 11, and thus the width of the optical device 100 in the X direction can be reduced.

Subsequently, an operation of the optical device 100 will be described. An output voltage from the optical device 100 changes in response to a change in the intensity of light radiated to the magnetic element 20. The output voltage from the optical device 100 changes in response to a change in a resistance value of the magnetic element 20 in the Z direction.

The magnetic element 20 is irradiated with the light L propagating along the waveguide 10. The light L propagates in the X direction in the waveguide 10, is reflected by each of the first reflector 41 and the second reflector 42, and is radiated to the magnetic element 20.

For example, when the intensity of the light radiated to the magnetic element 20 changes from a first intensity to a second intensity, the resistance value of the magnetic element 20 in the Z direction changes. For the first intensity, the intensity of the light radiated to the magnetic element 20 may be zero. When the resistance value of the magnetic element 20 in the Z direction changes, the output voltage from the magnetic element 20 changes.

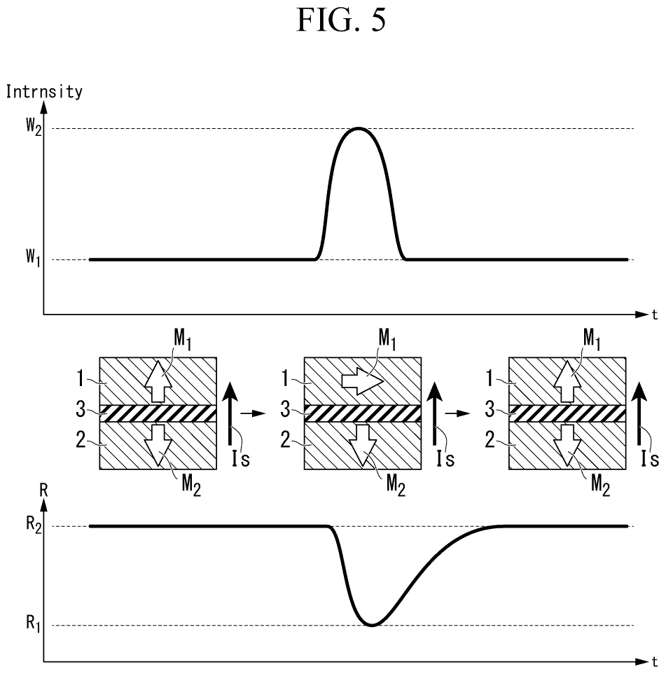

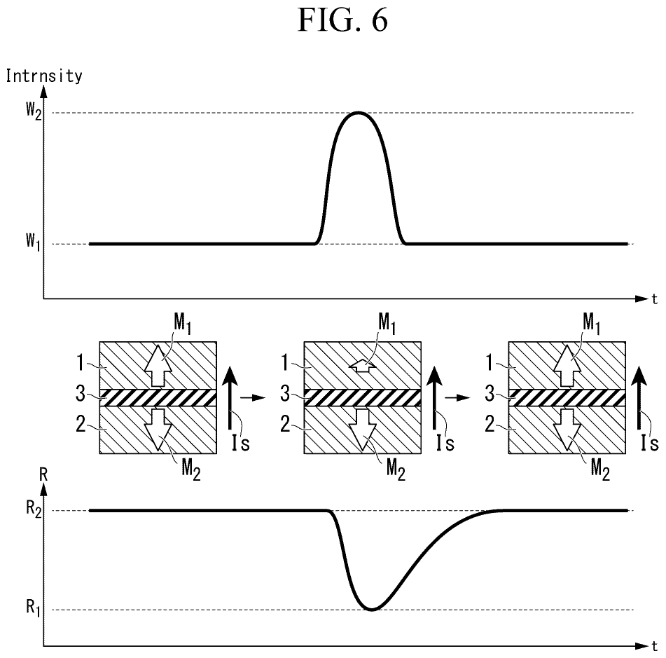

FIGS. 5 and 6 illustrate diagrams of operation examples of the magnetic element 20 according to the first embodiment. FIG. 5 illustrates a diagram of a first mechanism in an operation example. FIG. 6 illustrates a diagram of a second mechanism in an operation example. In upper graphs of FIGS. 5 and 6, the vertical axis represents an intensity of light radiated to the first ferromagnetic layer 1 and the horizontal axis represents a time. In lower graphs of FIGS. 5 and 6, the vertical axis represents a resistance value of the magnetic element 20 in the Z direction and the horizontal axis represents a time.

First, in a state where light with a first intensity W₁ is radiated to the first ferromagnetic layer 1 (hereinafter referred to as an initial state), the magnetization M₁ of the first ferromagnetic layer 1 and the magnetization M₂ of the second ferromagnetic layer 2 are in an antiparallel relationship, and the resistance value of the magnetic element 20 in the Z direction is a second resistance value R₂. Here, a state where the intensity of light radiated to the first ferromagnetic layer 1 is zero may be considered as a state where light with the first intensity W₁ is radiated.

By causing a sense current Is to flow in the Z direction of the magnetic element 20, a voltage is generated at both ends of the magnetic element 20 in the Z direction. An output voltage from the magnetic element 20 is generated between the first electrode 22 and the second electrode 23.

In the example illustrated in FIG. 5, the sense current Is preferably flows from the second ferromagnetic layer 2 to the first ferromagnetic layer 1. By causing the sense current Is to flow in this direction, a spin-transfer torque in a direction opposite to the magnetization M₂ of the second ferromagnetic layer 2 is applied to the magnetization M₁ of the first ferromagnetic layer 1, and thus in the initial state, the magnetization M₁ and the magnetization M₂ easily enter an antiparallel state.

Subsequently, the intensity of the light radiated to the first ferromagnetic layer 1 changes from the first intensity W₁ to the second intensity W₂. For example, when an optical pulse is radiated to the magnetic element 20, the intensity of the light radiated to the first ferromagnetic layer 1 changes from the first intensity W₁ to the second intensity W₂. Light with the second intensity W₂ has an intensity greater than light with the first intensity W₁.

The second intensity W₂ is greater than the first intensity W₁, which causing the magnetization M₁ of the first ferromagnetic layer 1 to change from the initial state. A state of the magnetization M₁ of the first ferromagnetic layer 1 when no light is radiated to the first ferromagnetic layer 1 differs from a state of the magnetization M₁ of the first ferromagnetic layer 1 when light with the second intensity W₂ is radiated. The state of magnetization M₁ is, for example, a tilt angle relative to the Z direction or magnitude.

For example, as illustrated in FIG. 5, when the intensity of light radiated to the first ferromagnetic layer 1 changes from the first intensity W₁ to the second intensity W₂, the magnetization M₁ tilts in the Z direction. Additionally, as illustrated in FIG. 6, when the intensity of light radiated to the first ferromagnetic layer 1 changes from the first intensity W₁ to the second intensity W₂, the magnitude of magnetization M₁ decreases. For instance, when the magnetization M₁ of the first ferromagnetic layer 1 tilts in the Z direction due to the intensity of the radiated light, a tilt angle is, for example, greater than 0° and less than 90°.

When the magnetization M₁ of the first ferromagnetic layer 1 changes from the initial state due to the radiation of optical pulses to the magnetic element 20, a resistance value of the magnetic element 20 in the Z direction is a first resistance value R₁, and the magnitude of an output voltage from the magnetic element 20 changes from a first value to a second value. As a result, the output from the optical device 100 changes. The first resistance value R₁ is less than the second resistance value R₂. The second value is less than the first value. The first resistance value R₁ is a value between a resistance value (second resistance value R₂) in a case where the magnetization M₁ and the magnetization M₂ are antiparallel and a resistance value in a case where the magnetizations M₁ and M₂ are parallel.

In the case illustrated in FIG. 5, a spin-transfer torque in an opposite direction to the magnetization M₂ of the second ferromagnetic layer 2 is applied to the magnetization M₁ of the first ferromagnetic layer 1. Accordingly, the magnetization M₁ attempts to return to the antiparallel state relative to the magnetization M₂. When the intensity of the light radiated to the first ferromagnetic layer 1 changes from the second intensity and the first intensity, the magnetization M₁ returns to the antiparallel state relative to the magnetization M₂. In the case illustrated in FIG. 6, when the intensity of the light radiated to the first ferromagnetic layer 1 returns to the first intensity W₁, the magnitude of the magnetization M₁ of the first ferromagnetic layer 1 is restored to the original magnitude and the magnetic element 20 is returned to the initial state. In either case, the resistance value of magnetic element 20 in the Z direction returns to the second resistance value R₂. That is, when the intensity of the light radiated to the first ferromagnetic layer 1 changes from the second intensity W₂ to the first intensity W₁, the resistance value of magnetic element 20 in the Z direction changes from the first resistance value R₁ to the second resistance value R₂.

The output voltage from the optical device 100 changes in response to a change in the intensity of the light radiated to the magnetic element 20, which converts the change in the intensity of the radiated light into the change in the output voltage from the magnetic element 20. That is, the optical device 100 can convert light into an electrical signal. For example, the output voltage from the optical device 100 is processed as a first signal (for example, “1”) when the output voltage is equal to or greater than a threshold. The output voltage is processed as a second signal (for example, “0”) when the output voltage is less than a threshold.

Here, the case where the magnetization M₁ and the magnetization M₂ are antiparallel in the initial state has been described as an example, but the the magnetization M₁ and the magnetization M₂ may be parallel in the initial state. In this case, the resistance value of the magnetic element 20 in the Z direction increases as the state of the magnetization M₁ changes (for example, as a change in an angle of the magnetization M₁ from the initial state increases). When the parallel state of the magnetization M₁ and the magnetization M₂ is the initial state, the sense current Is is preferably caused to flow from the first ferromagnetic layer 1 to the second ferromagnetic layer 2. When the sense current Is is caused to flow in this direction, a spin-transfer tongue in the same direction as the magnetization M₂ of the second ferromagnetic layer 2 is applied to the magnetization M₁ of the first ferromagnetic layer 1, and thus the magnetization M₁ and the magnetization M₂ become parallel in the initial state.

The case where the light radiated to the magnetic element 20 is in two intensity levels of the first intensity and the second intensity has been described as an example. The intensity of the light radiated to the magnetic element 20 may change in multiple levels or in an analog manner. In this case, the output voltage from the magnetic element 20 changes in multiple levels or in an analog manner.

The optical device 100 according to the first embodiment can change light into an electrical signal by changing the light radiated to the magnetic element 20 into an output voltage from the magnetic element 20. In the optical device 100 according to the first embodiment, the magnetic element 20 is in the cladding 12 to be packaged. Therefore, the waveguide 10 in which the light propagates and the magnetic element 20 which detects the light can be treated as a single component, which miniaturizes the optical device 100. The waveguide 10 and the magnetic element 20 are packaged together, and thus it is not necessary to adjust optical axes of the waveguide 10 and the magnetic element 20.

Further, the light propagating along the waveguide 10 is reflected by the first reflector 41 and the second reflector 42 and is radiated to the magnetic element 20 from the lateral side or the upper side of the magnetic element 20. Each layer included in the magnetic element 20 is considerably thin, and crystallinity of each layer is easily affected by an underlying substrate. When the light is radiated from the lower side of the magnetic element 20, a material of the first electrode 22 is limited, which cannot sufficiently enhance the crystallinity of the magnetic element 20. Conversely, in the optical device 100 according to the embodiment, the light is radiated from the lateral side or the upper side of the magnetic element 20, and thus a material of the first electrode 22 does not matter. As the crystallinity of the magnetic element 20 is enhanced, the resistance change range (MR ratio) of the magnetic element 20 increases, which enhances the sensitivity of the optical device 100.

The first embodiment has been described above as an example of the present invention, but the present invention is not limited to the embodiment.

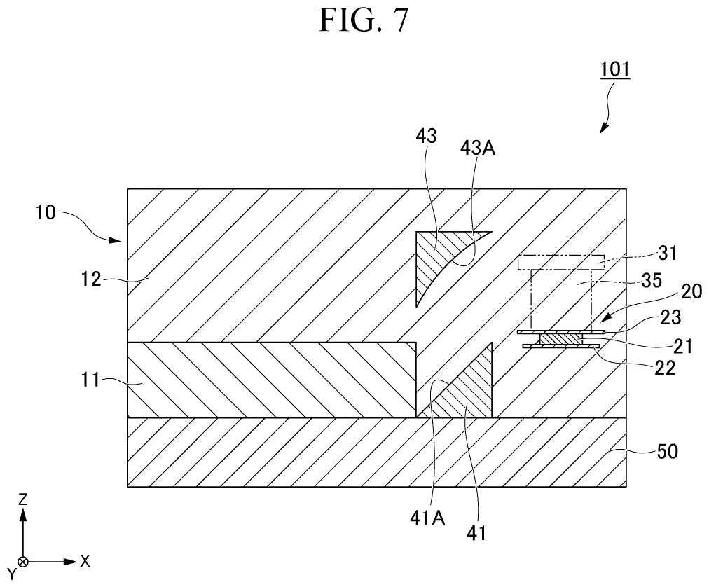

For example, FIG. 7 illustrates a sectional view of an optical device 101 according to a first modification. FIG. 7 illustrates an XZ cross-section passing the center of the core 11 in the Y direction. The optical device 101 illustrated in FIG. 7 includes the waveguide 10, the magnetic element 20, the terminal unit 30, the first reflector 41, a second reflector 43, and the substrate 50. The second reflector 43 has a different shape from the above-described second reflector 42. A reflection surface 43A of the second reflector 43 is curved. Light reflected by the reflection surface 43A is condensed and radiated to the magnetic element 20.

The optical device 101 according to the first modification can obtain the same advantages as the above optical device 100. In the optical device 101, the light is condensed by the reflection surface 43A, which enhances the radiation efficiency of the light to the magnetic element 20.

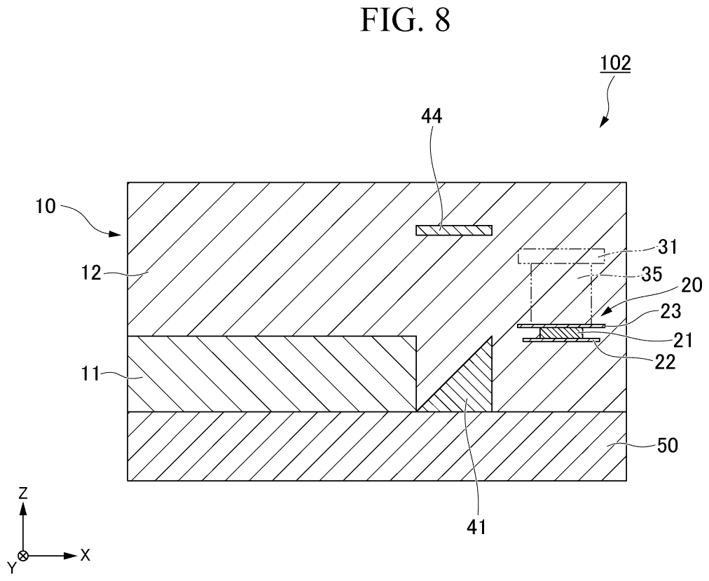

For example, FIG. 8 illustrates a sectional view of an optical device 102 according to a second modification. FIG. 8 illustrates an XZ cross-section passing the center of the core 11 in the Y direction. The optical device 102 illustrated in FIG. 8 includes the waveguide 10, the magnetic element 20, the terminal unit 30, the first reflector 41, a second reflector 44, and the substrate 50. The second reflector 44 has a different shape from the above-described second reflector 42.

The second reflector 44 is a metamirror that includes a meta-diffraction grating. The meta-diffraction grating is a type of metamaterial. The meta-diffraction grating is configured by a plurality of unit cells. Each unit cell contains a plurality of meta-atoms. The meta-diffraction grating can alter a distribution of a refractive index according to the shape of the unit cell. The metamirror exhibits a high reflectivity when light with a predetermined wavelength is irradiated. The predetermined wavelength can be controlled by modifying the configuration of the meta-diffraction grating.

The optical device 102 according to the second modification obtains the same advantages as the above optical device 100. The optical device 102 includes the second reflector 44 formed as the metamirror, and thus it is possible to control a wavelength or the like of light radiated to the magnetic element 20.

The example in which one magnetic element 20 is provided has been disclosed above, but the number of magnetic elements 20 may be plural.

When the plurality of magnetic elements 20 are provided, outputs from the magnetic elements 20 that behave similarly in response to light can be combined and output from the optical device. As a result, noise in an output signal of the optical device can be reduced, which improves a SN ratio of the optical device 102.

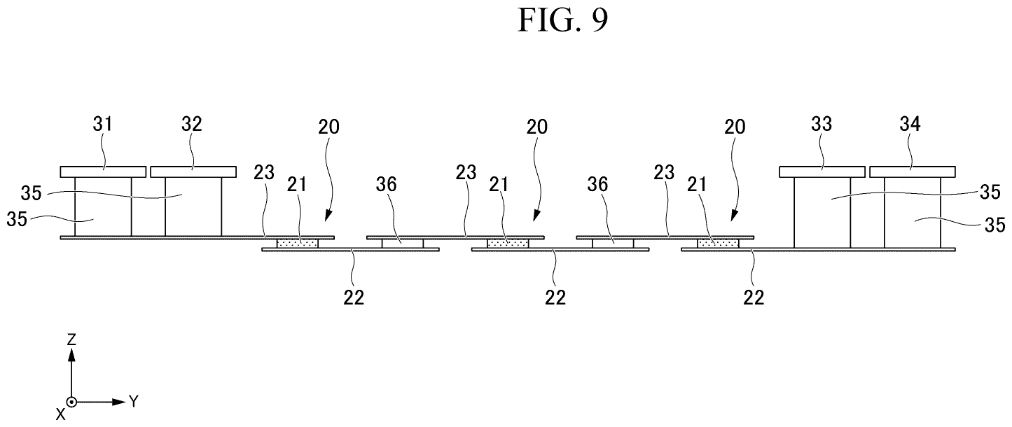

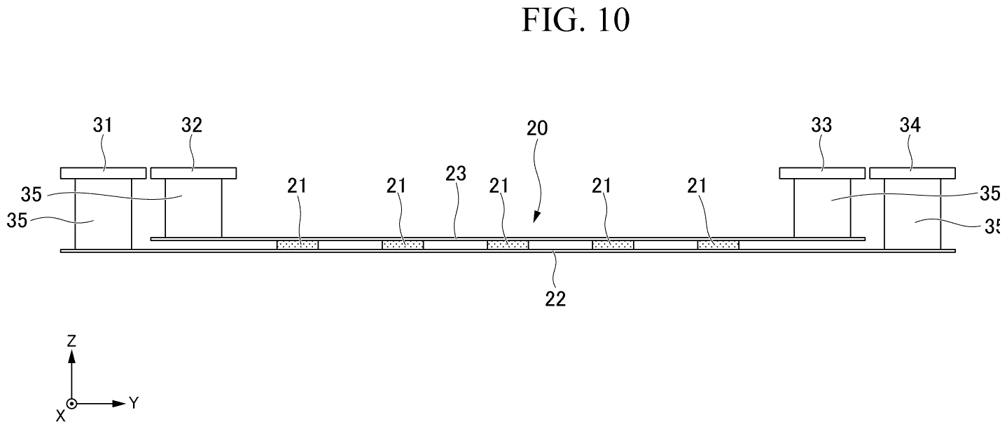

FIG. 9 illustrates a sectional view of a first example of a connection state of magnetic elements in an optical device according to a third modification. As illustrated in FIG. 9, the magnetic elements 20 may be connected in series. In FIG. 9, the magnetic elements 20 are connected in series via a connection wiring 36. FIG. 10 illustrates a sectional view of a second example of a connection state of magnetic elements in an optical device according to a third modification. As illustrated in FIG. 10, the magnetic elements 20 may be connected in parallel.

The example where two reflectors (the first reflector 41 and the second reflector 42) are provided between the core 11 and the magnetic element 20 in a light path has been described. However, the number of reflectors between the core 11 and the magnetic element 20 may be three or more.

The optical devices according to the above embodiments and modifications can be used for various uses.

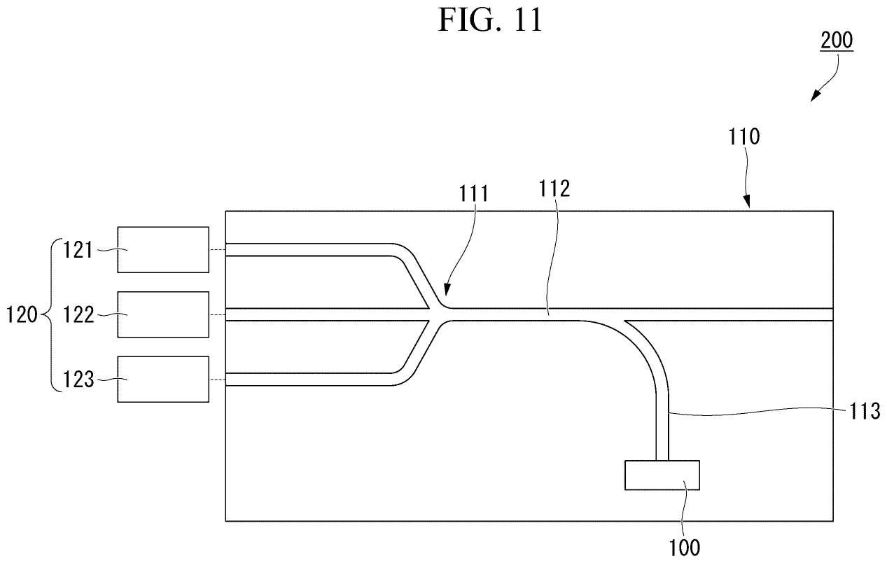

FIG. 11 illustrates a schematic view of the optical element 200 according to a first application. The optical element 200 illustrated in FIG. 11 includes a waveguide element 110 and a light source 120. The waveguide element 110 includes the above described light device 100 and a waveguide 111. The waveguide 111 includes an output waveguide 112 and a monitoring waveguide 113. The output waveguide 112 is a waveguide for outputting light from the light source 120 to the outside. The monitoring waveguide 113 is a waveguide for branching part of light propagating along the output waveguide 112 to the optical device 100. The monitoring waveguide 113 is connected to the core 11 of the optical device 100.

The light source 120 is, for example, a laser light source. The light source 120 includes, for example, a red laser 121, a green laser 122, and a blue laser 123. Light output from the light source 120 propagates along the output waveguide 112 to be output to the outside. Part of the light output from the light source 120 propagates along the monitoring waveguide 113 to reach the optical device 100.

The optical element 200 outputs laser light to the outside while monitoring an output from the light source 120 using the optical device 100. By adjusting intensity of the light output from each laser, the optical element 200 can adjust a white balance of the light output from the output waveguide 112 to the outside.

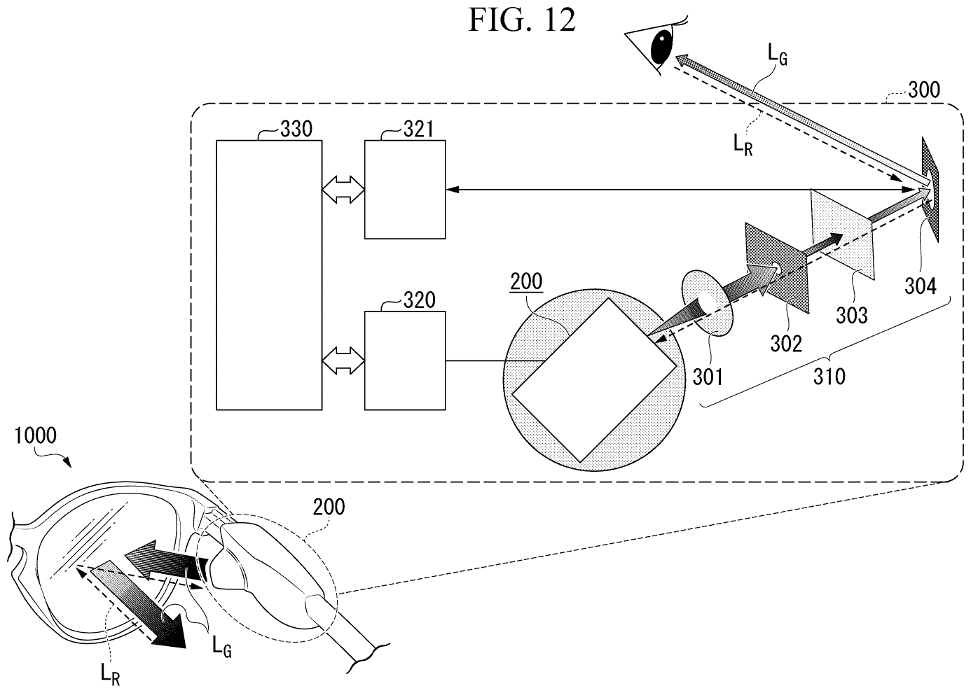

FIG. 12 illustrates a conceptual diagram of an optical system 300 in which the optical element 200 is used. The optical system 300 can be mounted on, for example, glasses 1000.

The optical system 300 includes the above optical element 200, an optical system 310, drivers 320 and 321, and a controller 330. The optical system 310 includes, for example, a collimator lens 301, a slit 302, an ND filter 303, and a light scanning mirror 304. The optical system 310 guides the light output from the optical element 200 to an irradiated object (in this example, an eye). The light scanning mirror 304 is, for example, a two-axis MEMS mirror that changes a reflection direction of the laser light horizontally and vertically. The optical system 310 is exemplary and not limited to this example. The driver 320 controls an output from the light source 120 of the optical element 200. The driver 321 is a control system that moves the light scanning mirror 304. The controller 330 controls drivers 320 and 321.

Light L_{G} output from the light source 120 of the optical element 200 propagates in the optical system 310, is reflected by a lens of the glasses 1000, and is incident on enters the eye. The example in which the light is reflected by the lens of the glasses 1000 has been described, but light may be directly radiated to the eye.

The red, green, and blue light L_{G} emitted from the light source 120 displays an image. The image can be freely controlled. An output intensity of each of the red laser 121, the green laser 122, and the blue laser 123 can be adjusted based on measurement results of outputs from the optical device 100 which is irradiated with the visible light output from each of the red laser 121, the green laser 122, and the blue laser 123.

When the optical system 300 is used, an image can be projected to the glasses 1000. By monitoring an intensity of projected light with the optical device 100, it is possible to adjust a color tone of the image.

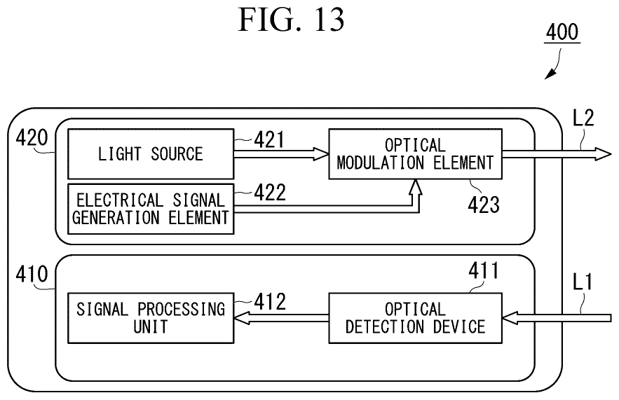

FIG. 13 illustrates a block diagram of a transceiver apparatus 400 according to a second application. The transceiver apparatus 400 includes a reception apparatus 410 and a transmission apparatus 420. The reception apparatus 410 receives an optical signal L1 and the transmission apparatus 420 transmits an optical signal L2.

The reception apparatus 410 includes, for example, an optical detection device 411 and a signal processing unit 412. The above-described optical device can be used as the optical detection device 411. In the reception apparatus 410, for example, optical pulses are radiated to the optical device of the optical detection device 411. The optical signal L1 is formed by the optical pulses. The optical detection device 411 converts the light signal L1 into an electrical signal. The signal processing unit 412 processes the electrical signal converted by the optical detection device 411. The signal processing unit 412 receives a signal included in the optical signal L by processing an electrical signal generated from the optical detection device 411. The reception apparatus 410 receives the signal included in the optical signal L1 based on an output signal from the optical detection device 411.

The transmission apparatus 420 includes, for example, a light source 421, an electrical signal generation element 422, and an optical modulation element 423. The light source 421 is, for example, a laser element. The light source 421 may be provided outside of the transmission apparatus 420. The electrical signal generation element 422 generates an electrical signal based on transmitted information. The electrical signal generation element 422 may be integrated with a signal conversion element of the signal processing unit 412. The optical modulation element 423 modulates light output from the light source 421 to output the optical signal L2 based on the electrical signal generated by the electrical signal generation element 422.

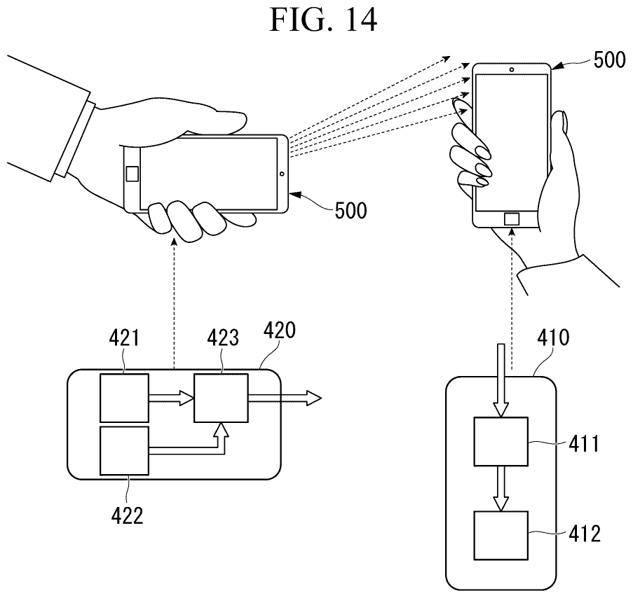

FIG. 14 illustrates a conceptual diagram of an example of a communication system. The communication system illustrated in FIG. 14 includes two terminal apparatuses 500. The terminal apparatus 500 is, for example, a smartphone, a tablet, a personal computer, or the like.

Each terminal apparatus 500 includes a reception apparatus 410 and a transmission apparatus 420. An optical signal transmitted from the transmission apparatus 420 of one terminal apparatus 500 is received by the reception apparatus 410 of the other terminal apparatus 500. Light used for transmission and reception between the terminal apparatuses 500 is, for example, visible light. The reception apparatus 410 includes the optical detection device 411.

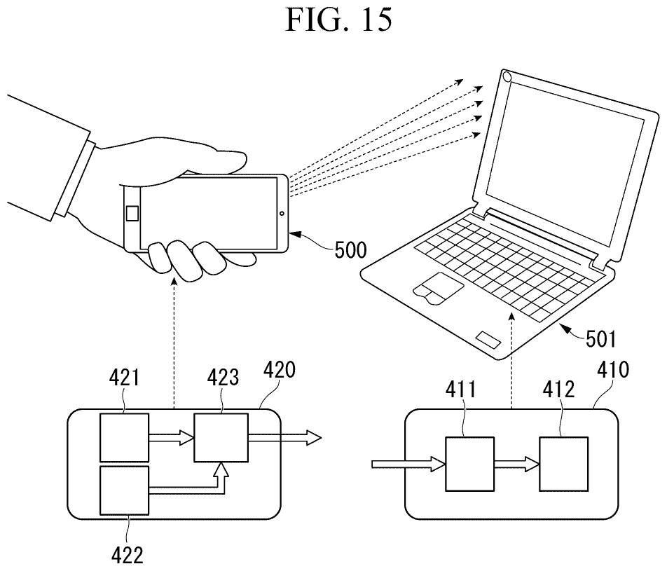

FIG. 15 is a conceptual diagram of an example of the communication system. In FIG. 14, the example in which the terminal apparatuses 500 are all smartphones has been described, but the terminal apparatuses 500 may differ between transmission and reception sides. For example, the terminal apparatus 500 illustrated in FIG. 15 is a smartphone and the terminal apparatus 501 is a personal computer.

### EXPLANATION OF REFERENCES

1 First ferromagnetic layer
2 Second ferromagnetic layer
3 Spacer layer
4 Buffer layer
5 Seed layer
6 Third ferromagnetic layer
7 Magnetic coupling layer
8 Perpendicular magnetization induction layer
9 Cap layer
10 Waveguide
11 Core
12 Cladding
20 Magnetic element
21 Stacked body
22 First electrode
23 Second electrode
30 Terminal unit
31 First terminal
32 Second terminal
33 Third terminal
34 Fourth terminal
35 Via wiring
36 Connection wiring
41 First reflector
42 Second reflector
50 Substrate
100, 101, 102 Optical device

What is claimed is:

1. An optical device comprising:
a waveguide;
a magnetic element;
a first reflector; and
a second reflector,
wherein the waveguide includes a core in which light propagates and a cladding covering the core,
wherein the first reflector is located forward in a traveling direction of the light propagating inside the core,
wherein the second reflector is located at a position at which the light reflected by the first reflector is radiated and the magnetic element is irradiated with the light,
wherein the magnetic element includes a first ferromagnetic layer, a second ferromagnetic layer, and a spacer layer located between the first ferromagnetic layer and the second ferromagnetic layer, and
wherein the magnetic element is irradiated with light from a lateral side or from above.

2. The optical device according to claim 1,
wherein the magnetic element is irradiated with light in a direction inclined by 45° or more with respect to an upper surface of the magnetic element.

3. The optical device according to claim 1,
wherein a reflection surface of the second reflector is curved, and
wherein the magnetic element is irradiated with light reflected from the reflection surface and condensed.

4. The optical device according to claim 1,
wherein the magnetic element includes a first electrode and a second electrode,
wherein the second electrode is located above the first electrode, and
wherein the first electrode is formed of a metal containing at least one element selected from a group consisting of copper, aluminum, gold, tantalum, titanium, ruthenium, molybdenum, and tungsten.

5. The optical device according to claim 1, wherein the number of magnetic elements is plural.

6. A reception apparatus comprising the optical device according to claim 1.

7. A transceiver apparatus comprising the reception apparatus according to claim 6.

8. A communication system comprising the reception apparatus according to claim 6.

9. A terminal apparatus comprising the reception apparatus according to claim 6.

10. An optical system comprising the optical device according to claim 1.
